(19) United States
(12) Patent Application Publication
(10) Pub. No.: US 2008/0087142 A1
(43) Pub. Date: Apr. 17, 2008

(54) Screwdriver having quick release tool shank background of the invention

(75) Inventor: Jack Lin, Nantou County (TW)

Correspondence Address: Dr. BANGER SHIA, 102 Lindencrest Ct., Sugar Land, TX, 77479-5201, US

(73) Assignee: Yih Cheng Factory Co., Ltd, Nantou County (TW)

(21) Appl. No.: 11/581,438

(22) Filed: Oct. 17, 2006

(51) Int. Cl. B25B 23/16; B25G 1/00; B25B 15/00; B25B 23/00

(52) U.S. Cl. 81/177.1; 81/436; 81/438

(57) ABSTRACT

A screwdriver includes a handle, a fixing member mounted in the handle, a release member slidably mounted on and axially movable relative to the fixing member, and a tool shank locked on the release member and detachable from the release member by movement of the release member relative to the fixing member. Thus, the tool shank is supported by the fixing member and the release member which are supported by the handle to enhance the strength of the screwdriver so that the screwdriver is not easily broken or worn out, thereby enhancing the lifetime of the screwdriver. In addition, the tool shank is mounted on and detached from the fixing member and the handle by pressing the release member, thereby facilitating the user mounting and replacing the tool shank.

### BACKGROUND OF THE INVENTION

1. Field of the Invention

The present invention relates to a screwdriver, and more particularly to a screwdriver having a quick release tool shank.

2. Description of the Related Art

A conventional screwdriver comprises a handle, and a tool shank secured in the handle and having a front end formed with a polygonal insertion hole to allow insertion of a tip. However, the front end of the tool shank defining the polygonal insertion hole has a wall with a reduced thickness, so that the front end of the tool shank is easily broken or worn out during a long-term utilization, thereby decreasing the lifetime of the screwdriver.

### SUMMARY OF THE INVENTION

The present invention is to mitigate and/or obviate the disadvantage of the conventional screwdriver.

The primary objective of the present invention is to provide a screwdriver having a quick release tool shank.

Another objective of the present invention is to provide a screwdriver, wherein the tool shank is supported by the fixing member and the release member which are supported by the handle so as to enhance the strength of the screwdriver so that the screwdriver is not easily broken or worn out during a long-term utilization, thereby greatly enhancing the lifetime of the screwdriver, and thereby facilitating a user operating the screwdriver.

A further objective of the present invention is to provide a screwdriver, wherein the tool shank is mounted on and detached from the fixing member and the handle by pressing the release member, thereby facilitating the user mounting and replacing the tool shank.

In accordance with the present invention, there is provided a screwdriver, comprising a handle, a fixing member mounted in the handle, a release member slidably mounted on and axially movable relative to the fixing member, and a tool shank locked on the release member and detachable from the release member by movement of the release member relative to the fixing member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a screwdriver in accordance with the preferred embodiment of the present invention;

FIG. 2 is an exploded perspective view of the screwdriver as shown in FIG. 1;

FIG. 3 is a plan cross-sectional view of the screwdriver as shown in FIG. 1;

FIG. 4 is a plan cross-sectional view of the screwdriver as shown in FIG. 1;

FIG. 5 is a schematic operational view of the screwdriver as shown in FIG. 4;

FIG. 6 is a schematic operational view of the screwdriver as shown in FIG. 5; and

FIG. 7 is a partially exploded perspective view of a screwdriver in accordance with another preferred embodiment of the present invention.

### DETAILED DESCRIPTION OF THE INVENTION

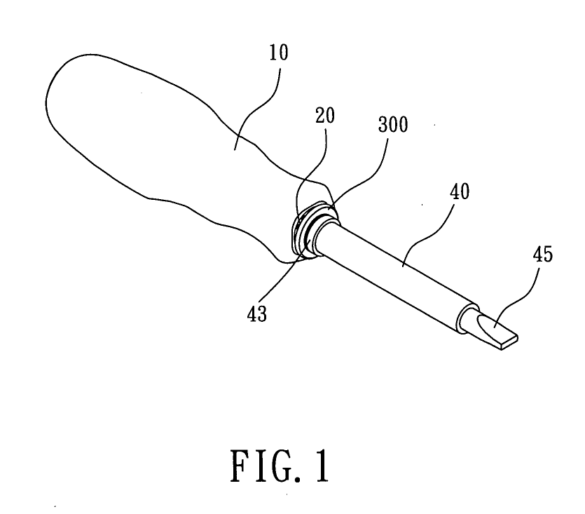

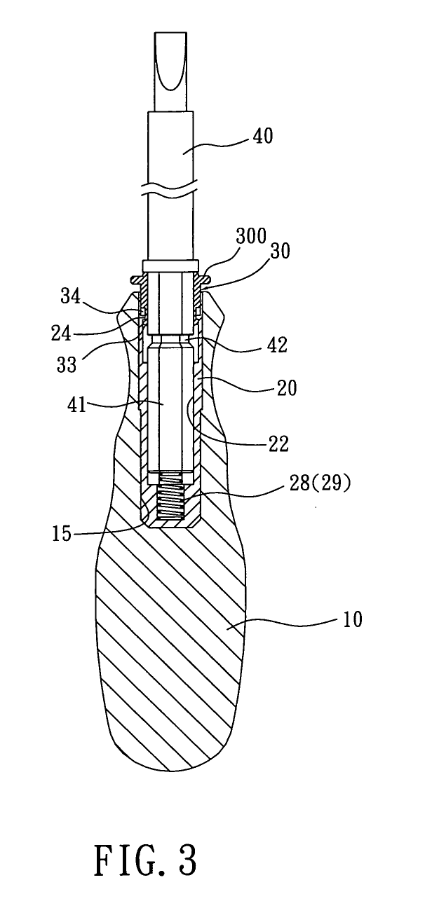

Referring to the drawings and initially to FIGS. 1-4, a screwdriver in accordance with the preferred embodiment of the present invention comprises a handle 10, a fixing member 20 mounted in the handle 10, a release member 30 slidably mounted on and axially movable relative to the fixing member 20, and a tool shank 40 locked on the release member 30 and detachable from the release member 30 by movement of the release member 30 relative to the fixing member 20.

The handle 10 has an end portion formed with a receiving slot 15 to allow insertion of the fixing member 20.

The fixing member 20 is inserted into and fully hidden in the receiving slot 15 of the handle 10. The fixing member 20 has an outer wall formed with a tooth-shaped engaging portion 21 engaged in a wall of the receiving slot 15 of the handle 10 so that the fixing member 20 is secured in and not rotatable relative to the handle 10. The fixing member 20 has an inside formed with an axially extending insertion slot 22 to allow insertion of the release member 30 and the tool shank 40 and has a peripheral wall formed with a radially extending through hole 25 communicating with the insertion slot 22. The insertion slot 22 of the fixing member 20 has a distal end formed with an axially extending serrated slideway 23 and an inwardly extending annular stop flange 24 located between the slideway 23 and the through hole 25. The peripheral wall of the fixing member 20 defining the through hole 25 is provided with two opposite push blocks 26 each exposed from the through hole 25 and each having a tapered guide face 27 directed outwardly from the through hole 25.

The release member 30 has an outer wall formed with an axially extending serrated slide 32 slidably mounted in the slideway 23 of the fixing member 20 so that the release member 30 is axially slidable and not rotatable relative to the fixing member 20. The release member 30 has an inside formed with an axially extending polygonal mounting hole 31 to mount and allow passage of the tool shank 40. The release member 30 has a first side formed with two opposite elastic snapping plates 35 each movable in the fixing member 20 and each having a distal end formed with an inwardly extending snapping block 36 which is snapped onto the tool shank 40 to lock the tool shank 40 and has a tapered guide face 37 rested on and pushed by the tapered guide face 27 of a respective push block 26 of the fixing member 20. The first side of the release member 30 is also formed with two opposite recessed limit plates 34 each slidable on the stop flange 24 of the fixing member 20 and each formed with an outwardly extending limit flange 33 that is movable to rest on the stop flange 24 of the fixing member 20 to prevent the release member 30 from detaching from the fixing member 20. The release member 30 has a second side formed with an outwardly extending annular resting flange 300 that is movable to rest on the fixing member 20 and the handle 10 to prevent the release member 30 from being fully extended into the fixing member 20.

The tool shank 40 has a first end formed with a polygonal mounting portion 41 having a locking groove 42 for releasably locking the snapping blocks 36 of the snapping plates 35 of the release member 30 to lock the tool shank 40 onto the release member 30, a mediate portion formed with a limit ring 43 that is movable to rest on the release member 30, and a second end provided with a tip 45. The mounting portion 41 of the tool shank 40 is extended through the mounting hole 31 of the release member 30 into the insertion slot 22 of the fixing member 20.

An elastic member 28 is mounted in the insertion slot 22 of the fixing member 20 and biased between the fixing member 20 and the mounting portion 41 of the tool shank 40 to push the tool shank 40 outwardly relative to the fixing member 20 and the release member 30. The insertion slot 22 of the fixing member 20 has a bottom wall formed with a retaining groove 29 to retain the elastic member 28 to prevent the elastic member 28 from detaching from the insertion slot 22 of the fixing member 20.

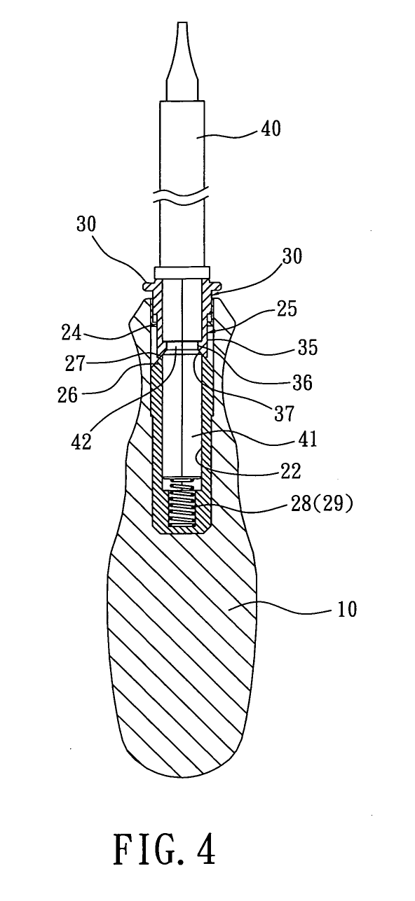

In operation, referring to FIGS. 1-6, the snapping block 36 of each of the snapping plates 35 of the release member 30 is initially extended into the insertion slot 22 of the fixing member 20 and snapped into the locking groove 42 of the tool shank 40 so as to lock the tool shank 40 onto the release member 30 as shown in FIG. 4.

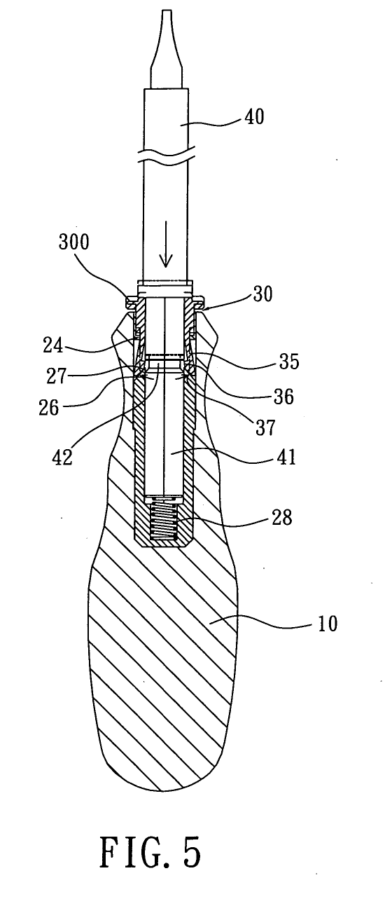

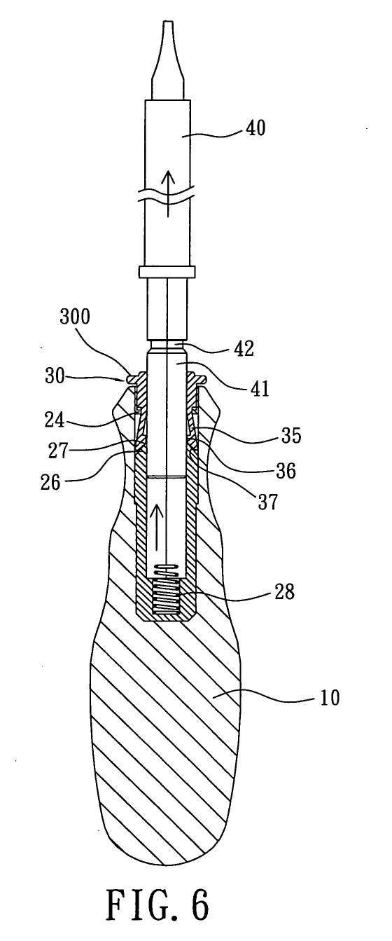

When the release member 30 is pressed toward the fixing member 20 to move from the position as shown in FIG. 4 to the position as shown in FIG. 5, the tapered guide face 37 of the snapping block 36 of each of the snapping plates 35 of the release member 30 is pushed outwardly by the tapered guide face 27 of a respective push block 26 of the fixing member 20, so that each of the snapping plates 35 of the release member 30 is pushed outwardly relative to the tool shank 40 to push the snapping block 36 of each of the snapping plates 35 of the release member 30 outwardly from the insertion slot 22 of the fixing member 20 and to detach the snapping block 36 of each of the snapping plates 35 of the release member 30 from the locking groove 42 of the tool shank 40 so as to release the tool shank 40 from the release member 30. At the same time, the tool shank 40 is pushed outwardly relative to the fixing member 20 and the release member 30 by the restoring force of the elastic member 28 as shown in FIG. 6, so that the tool shank 40 is detached from the fixing member 20 and the release member 30 for replacement of the tool shank 40.

When the release member 30 is pressed toward the fixing member 20 again, the tapered guide face 37 of the snapping block 36 of each of the snapping plates 35 of the release member 30 is pushed outwardly by the tapered guide face 27 of a respective push block 26 of the fixing member 20, so that each of the snapping plates 35 of the release member 30 is pushed outwardly relative to the tool shank 40 to push the snapping block 36 of each of the snapping plates 35 of the release member 30 outwardly from the insertion slot 22 of the fixing member 20 as shown in FIG. 5. Then, the mounting portion 41 of the tool shank 40 is extended through the mounting hole 31 of the release member 30 into the insertion slot 22 of the fixing member 20 until the locking groove 42 of the tool shank 40 is aligned with the snapping block 36 of each of the snapping plates 35 of the release member 30. Finally, the force applied on the release member 30 is released, so that each of the snapping plates 35 of the release member 30 is contracted inwardly by its elasticity, and the snapping block 36 of each of the snapping plates 35 of the release member 30 is snapped into the locking groove 42 of the tool shank 40 so as to lock the tool shank 40 onto the release member 30 as shown in FIG. 4. At this time, the elastic member 28 is compressed by the tool shank 40 to store the restoring force.

Accordingly, the tool shank 40 is supported by the fixing member 20 and the release member 30 which are supported by the handle 10 so as to enhance the strength of the screwdriver so that the screwdriver is not easily broken or worn out during a long-term utilization, thereby greatly enhancing the lifetime of the screwdriver, and thereby facilitating a user operating the screwdriver. In addition, the tool shank 40 is mounted on and detached from the fixing member 20 and the handle 10 by pressing the release member 30, thereby facilitating the user mounting and replacing the tool shank 40.

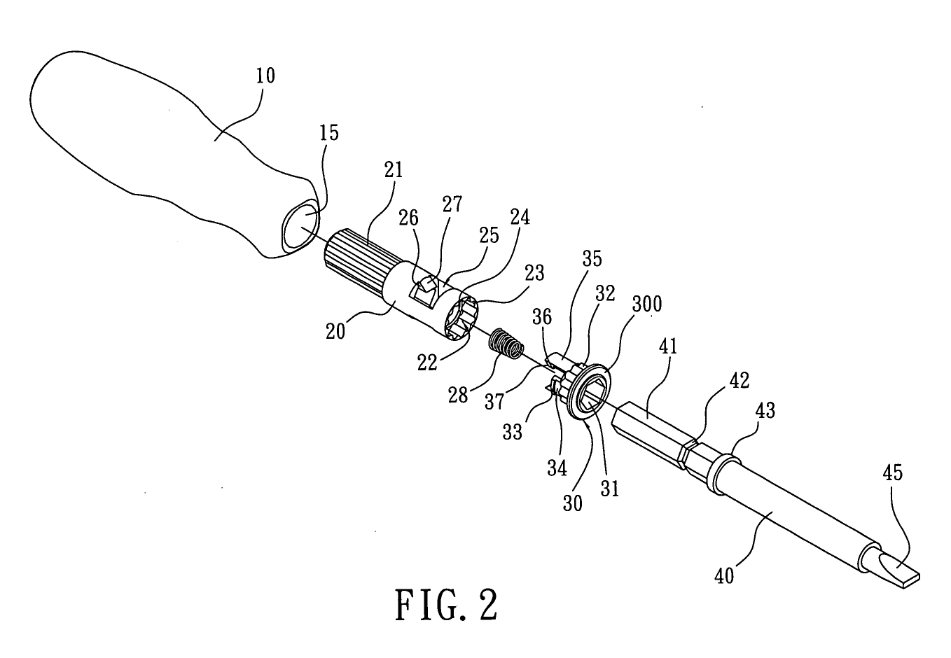

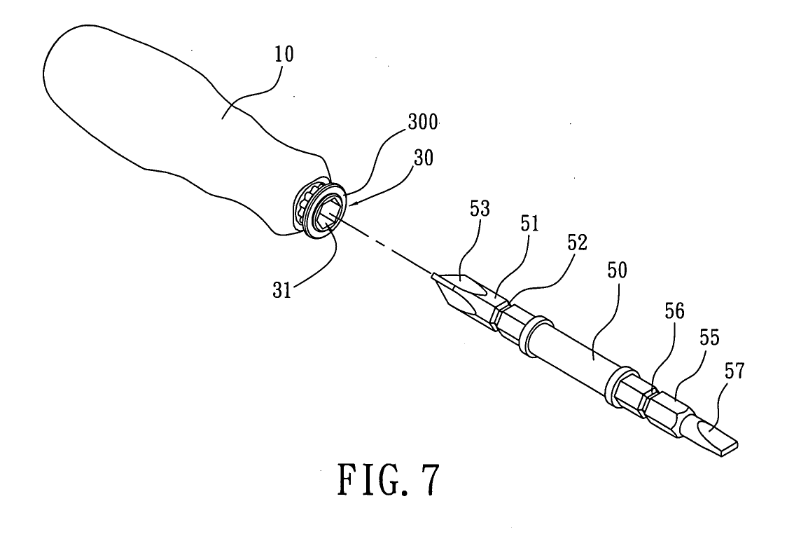

Referring to FIGS. 2 and 7, the tool shank 50 has a first end formed with a polygonal first mounting portion 51 having a first locking groove 52 for releasably locking the snapping blocks 36 of the snapping plates 35 of the release member 30 to lock the tool shank 50 onto the release member 30 and a second end formed with a polygonal second mounting portion 55 having a second locking groove 56 for releasably locking the snapping blocks 36 of the snapping plates 35 of the release member 30 to lock the tool shank 50 onto the release member 30. The first mounting portion 51 of the tool shank 50 is extended through the mounting hole 31 of the release member 30 into the insertion slot 22 of the fixing member 20 and has a distal end formed with a first tip 53, and the second mounting portion 55 of the tool shank 50 is extended through the mounting hole 31 of the release member 30 into the insertion slot 22 of the fixing member 20 and has a distal end formed with a second tip 57.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A screwdriver, comprising:
a handle;
a fixing member mounted in the handle;
a release member slidably mounted on and axially movable relative to the fixing member;
a tool shank locked on the release member and detachable from the release member by movement of the release member relative to the fixing member; wherein the fixing member has an inside formed with an axially extending insertion slot to allow insertion of the release member and the tool shank and has a peripheral wall formed with a radially extending through hole communicating with the insertion slot;
the peripheral wall of the fixing member defining the through hole is provided with two opposite push blocks each exposed from the through hole and each having a tapered guide face directed outwardly from the through hole;
the release member has a first side formed with two opposite elastic snapping plates each movable in the fixing member and each having a distal end formed with an inwardly extending snapping block which is snapped onto the tool shank to lock the tool shank and has a tapered guide face rested on and pushed by the tapered guide face of a respective push block of the fixing member.

2. The screwdriver in accordance with claim 1, wherein the handle has an end portion formed with a receiving slot to allow insertion of the fixing member.

3. The screwdriver in accordance with claim 1, wherein the fixing member is inserted into and fully hidden in the receiving slot of the handle.

4. The screwdriver in accordance with claim 1, wherein the fixing member has an outer wall formed with a tooth-shaped engaging portion engaged in a wall of the receiving slot of the handle so that the fixing member is secured in and not rotatable relative to the handle.

5. (canceled)

6. The screwdriver in accordance with claim 1, wherein the insertion slot of the fixing member has a distal end formed with an axially extending serrated slideway, and the release member has an outer wall formed with an axially extending serrated slide slidably mounted in the slideway of the fixing member so that the release member is axially slidable and not rotatable relative to the fixing member.

7. The screwdriver in accordance with claim 1, wherein the insertion slot of the fixing member has a distal end formed with an inwardly extending annular stop flange, and the first side of the release member is also formed with two opposite recessed limit plates each slidable on the stop flange of the fixing member and each formed with an outwardly extending limit flange that is movable to rest on the stop flange of the fixing member to prevent the release member from detaching from the fixing member.

8. The screwdriver in accordance with claim 1, wherein the release member has a second side formed with an outwardly extending annular resting flange that is movable to rest on the fixing member and the handle to prevent the release member from being fully extended into the fixing member.

9. The screwdriver in accordance with claim 1, wherein the tool shank has a first end formed with a polygonal mounting portion having a locking groove for releasably locking the snapping blocks of the snapping plates of the release member to lock the tool shank onto the release member.

10. The screwdriver in accordance with claim 9, wherein the release member has an inside formed with an axially extending polygonal mounting hole to mount and allow passage of the tool shank, and the mounting portion of the tool shank is extended through the mounting hole of the release member into the insertion slot of the fixing member.

11. The screwdriver in accordance with claim 9, wherein the tool shank has a mediate portion formed with a limit ring that is movable to rest on the release member.

12. The screwdriver in accordance with claim 9, wherein the tool shank has a second end provided with a tip.

13. The screwdriver in accordance with claim 9, further comprising an elastic member mounted in the insertion slot of the fixing member and biased between the fixing member and the mounting portion of the tool shank to push the tool shank outwardly relative to the fixing member and the release member.

14. The screwdriver in accordance with claim 13, wherein the insertion slot of the fixing member has a bottom wall formed with a retaining groove to retain the elastic member to prevent the elastic member from detaching from the insertion slot of the fixing member.

15. The screwdriver in accordance with claim 1, wherein the snapping block of each of the snapping plates of the release member is extended into the insertion slot of the fixing member.

16. The screwdriver in accordance with claim 9, wherein when the release member is pressed toward the fixing member, the tapered guide face of the snapping block of each of the snapping plates of the release member is pushed outwardly by the tapered guide face of a respective push block of the fixing member, so that each of the snapping plates of the release member is pushed outwardly relative to the tool shank to push the snapping block of each of the snapping plates of the release member outwardly from the insertion slot of the fixing member and to detach the snapping block of each of the snapping plates of the release member from the locking groove of the tool shank so as to release the tool shank from the release member.

17. The screwdriver in accordance with claim 1, wherein the tool shank has a first end formed with a polygonal first mounting portion having a first locking groove for releasably locking the snapping blocks of the snapping plates of the release member to lock the tool shank onto the release member and a second end formed with a polygonal second mounting portion having a second locking groove for releasably locking the snapping blocks of the snapping plates of the release member to lock the tool shank onto the release member.

18. The screwdriver in accordance with claim 17, wherein the release member has an inside formed with an axially extending polygonal mounting hole to mount and allow passage of the tool shank, the first mounting portion of the tool shank is extended through the mounting hole of the release member into the insertion slot of the fixing member and has a distal end formed with a first tip, and the second mounting portion of the tool shank is extended through the mounting hole of the release member into the insertion slot of the fixing member and has a distal end formed with a second tip.
